(19) United States
(12) Patent Application Publication
(10) Pub. No.: US 2025/0266735 A1
(43) Pub. Date: Aug. 21, 2025

(54) MOTOR

(71) Applicant: HYUNDAI MOBIS CO., LTD., Seoul (KR)

(72) Inventors: Yeong Woo SEO, Yongin-si (KR); Jung Kyu YIM, Yongin-si (KR); Sang Jin KIM, Yongin-si (KR); Seung Ho LEE, Yongin-si (KR); Myung Jun GAM, Yongin-si (KR); Hee Seo PARK, Yongin-si (KR)

(73) Assignee: HYUNDAI MOBIS CO., LTD., Seoul (KR)

(21) Appl. No.: 19/035,304

(22) Filed: Jan. 23, 2025

(30) Foreign Application Priority Data
Feb. 20, 2024 (KR) 10-2024-0024466

(51) Int. Cl. H02K 5/20; H02K 1/16

(52) U.S. Cl. CPC H02K 5/20; H02K 1/16

(57) ABSTRACT

The present disclosure relates to a motor including a stator, a coil wound around the stator, a housing member provided to surround a circumference of the stator and having a cooling medium injection portion through which a cooling medium is injected, a guide flow path defined between the housing member and the stator and configured to communicate with the cooling medium injection portion and guide the cooling medium, and a guide member provided at an end of the housing member and configured to guide the cooling medium, which is discharged from the guide flow path, toward an end-turn portion of the coil exposed to an end of the stator, thereby obtaining an advantageous effect of improving cooling performance, stability, and reliability.

### CROSS-REFERENCE TO RELATED APPLICATION

This application claims priority to and the benefit of Korean Patent Application No. 10-2024-0024466 filed in the Korean Intellectual Property Office on Feb. 20, 2024, the entire contents of which are incorporated herein by reference.

### TECHNICAL FIELD

The present disclosure relates to a motor, and more particularly, to a motor capable of improving cooling performance, safety, and reliability.

### BACKGROUND ART

A hybrid vehicle or an electric vehicle, which is called an environmentally friendly vehicle, generates driving power using an electric motor (hereinafter, referred to as a ‘drive motor’) that obtains rotational force from electrical energy.

In general, the drive motor includes a stator coupled to a housing, and a rotor rotatably disposed in the stator with a predetermined air gap from the stator.

The stator includes a core made by stacking electric steel sheets and having a plurality of coil winding portions, and a stator coil wound around the core.

Meanwhile, high-temperature heat is generated in the motor because of eddy currents created in the stator. When the temperature of the motor is raised to a predetermined temperature, the efficiency and lifespan of the motor may deteriorate. Therefore, it is necessary to essentially cool the motor to prevent damage caused by heat and consistently enable stable operability.

However, in the related art, it is difficult to effectively cool an end-turn portion of the coil exposed (protruding) to an end of the stator. For this reason, it is difficult to ensure sufficient performance in cooling the motor.

Recently, various studies have been conducted to improve the performance in cooling the motor, but the study results are still insufficient. Accordingly, there is a need to develop a technology to improve the performance in cooling the motor.

### SUMMARY

The present disclosure has been made in an effort to provide a motor for an electric vehicle, which is capable of improving cooling performance, stability, and reliability.

In particular, the present disclosure has been made in an effort to effectively ensure efficiency and performance in cooling an end-turn portion of a coil.

The present disclosure has also been made in an effort to simplify a structure and reduce costs.

The present disclosure has also been made in an effort to minimize power consumption and improve energy efficiency.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides a motor including: a stator; a coil wound around the stator; a housing member provided to surround a circumference of the stator and having a cooling medium injection portion through which a cooling medium is injected; a guide flow path defined between the housing member and the stator and configured to communicate with the cooling medium injection portion and guide the cooling medium; and a guide member provided at an end of the housing member and configured to guide the cooling medium, which is discharged from the guide flow path, toward an end-turn portion of the coil exposed to an end of the stator.

This is to improve the performance in cooling the motor and improve the stability and reliability.

That is, high-temperature heat is generated in the motor because of eddy currents created in the stator. When the temperature of the motor is raised to a predetermined temperature, the efficiency and lifespan of the motor may deteriorate. Therefore, it is necessary to essentially cool the motor to prevent damage caused by heat and consistently enable stable operability.

However, in the related art, it is difficult to effectively cool an end-turn portion of the coil exposed (protruding) to an end of the stator. For this reason, it is difficult to ensure sufficient performance in cooling the motor.

In contrast, in the embodiment of the present disclosure, the cooling medium discharged along the guide flow path is guided to the end-turn portion of the coil by means of the guide member. Therefore, it is possible to obtain an advantageous effect of improving the stability, reliability, and performance in cooling the motor.

Among other things, in the embodiment of the present disclosure, the cooling medium injected into the cooling medium injection portion not only cools the core portion of the coil (or the stator) while moving along the guide flow paths, but also is concentratedly sprayed, by means of the guide member, to the end-turn portions of the coil that generate a relatively large amount of heat. Therefore, it is possible to obtain an advantageous effect of minimizing a temperature deviation (cooling performance deviation) between the core portion of the coil and the end-turn portion and more effectively eliminating heat generated by the stator and the coil.

The guide member may have various structures capable of guiding the cooling medium, which is discharged from the guide flow path, to the end-turn portion of the coil.

According to the exemplary embodiment of the present disclosure, the guide member may include: a connection portion connected to the end of the housing member; and a guide portion provided at an end of the connection portion and configured to guide the cooling medium, which is discharged from the guide flow path, toward the end-turn portion.

According to the exemplary embodiment of the present disclosure, the guide portion may be provided to be inclined with respect to the connection portion and directed toward the end-turn portion.

As described above, in the embodiment of the present disclosure, the guide portion is provided to be inclined with respect to the connection portion. Therefore, it is possible to obtain an advantageous effect of minimizing a situation in which the cooling medium discharged from the guide flow path scatters backward in random directions when the cooling medium comes into contact with the guide portion. Further, it is possible to obtain an advantageous effect of more accurately controlling a spray direction of the cooling medium to the direction toward the end-turn portion of the coil.

According to the exemplary embodiment of the present disclosure, the motor may include: an inclined guiding portion provided integrally with the end of the housing member and configured to guide the cooling medium, which is discharged from the guide flow path, toward the end-turn portion.

As described above, in the embodiment of the present disclosure, the inclined guiding portion is provided at the end of the housing member. Therefore, it is possible to obtain an advantageous effect of more accurately controlling the spray direction of the cooling medium, which is discharged from the guide flow path, to the direction toward the end-turn portion of the coil.

According to the exemplary embodiment of the present disclosure, the motor may include: a guide baffle provided on an inner circumferential surface of the guide portion and protruding in a longitudinal direction of the housing member.

As described above, in the embodiment of the present disclosure, the guide baffles are provided on the inner circumferential surface of the guide portion, such that the cooling medium discharged from the guide flow path may be guided to the end-turn portion of the coil without stagnating on the inner circumferential surface of the guide portion or flowing downward to a lower end of the guide portion in a circumferential direction of the guide portion. Therefore, it is possible to obtain an advantageous effect of more accurately controlling the supply direction of the cooling medium to the direction toward the end-turn portion of the coil.

According to the exemplary embodiment of the present disclosure, the motor may include: a guide groove provided in an outer surface of the stator in a longitudinal direction of the stator, in which the guide flow path is defined along the guide groove.

According to the exemplary embodiment of the present disclosure, the motor may include: a guide protrusion provided at an end of the guide groove and configured to define an outlet flow path having a smaller cross-sectional area than the guide flow path.

As described above, in the embodiment of the present disclosure, the outlet flow path, through which the cooling medium supplied along the guide flow path is finally discharged, has a smaller cross-sectional area than the guide flow path, such that a discharge speed of the cooling medium to be discharged along the outlet flow path may be increased on the basis of the Bernoulli's principle, and the cooling medium may be sprayed to the end-turn portions of the coil. Therefore, it is possible to obtain an advantageous effect of further improving the efficiency and performance in cooling the end-turn portions of the coil.

According to the exemplary embodiment of the present disclosure, the motor may include: a guide clip provided at an end of the guide groove and configured to guide the cooling medium toward the end-turn portion.

The guide clip may have various structures capable of guiding the cooling medium, which is discharged from the guide flow path, to the end-turn portion of the coil.

According to the exemplary embodiment of the present disclosure, the guide clip may include: a head portion provided at the end of the guide groove; a first leg portion connected to one end of the head portion and supported on a first inner wall surface of the guide groove; a second leg portion connected to the other end of the head portion and supported on a second inner wall surface of the guide groove that faces the first inner wall surface; a discharge flow path defined between the first leg portion and the second leg portion and configured to guide the cooling medium, which moves along the guide flow path, to an inner surface of the head portion; and an inclined portion provided on the inner surface of the head portion and configured to guide the cooling medium toward the end-turn portion.

The discharge flow path may have various structures capable of guiding the cooling medium, which moves along the guide flow path, to the inner surface of the head portion.

According to the exemplary embodiment of the present disclosure, the discharge flow path may be defined to have a cross-sectional area that gradually decreases from an inlet, which is adjacent to a central portion of the stator, toward an outlet.

As described above, in the embodiment of the present disclosure, the discharge flow path has a cross-sectional area that gradually decreases from the inlet toward the outlet, such that a discharge speed of the cooling medium to be discharged through the outlet of the outlet flow path may be increased on the basis of the Bernoulli's principle, and the cooling medium may be sprayed to the inner surface (inclined portion) of the head portion. Therefore, it is possible to obtain an advantageous effect of further improving the efficiency and performance in cooling the end-turn portion of the coil.

According to the embodiment of the present disclosure described above, it is possible to obtain an advantageous effect of improving the cooling performance, stability, and reliability.

In particular, according to the embodiment of the present disclosure, it is possible to obtain an advantageous effect of effectively ensuring the efficiency and performance in cooling the end-turn portion of the coil.

In addition, according to the embodiment of the present disclosure, it is possible to obtain an advantageous effect of simplifying the structure and reducing the costs.

In addition, according to the embodiment of the present disclosure, it is possible to obtain an advantageous effect of minimizing electric power consumption and improving energy efficiency.

### BRIEF DESCRIPTION OF THE DRAWINGS

FIG. 1 is a view for explaining a motor according to an embodiment of the present disclosure.

FIG. 2 is a view for explaining a guide member of the motor according to the embodiment of the present disclosure.

FIG. 3 is a view for explaining guide protrusions of the motor according to the embodiment of the present disclosure.

FIGS. 4 and 5 are views for explaining a modified example of the guide member of the motor according to the embodiment of the present disclosure.

FIGS. 6 to 8 are views for explaining a guide clip of the motor according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

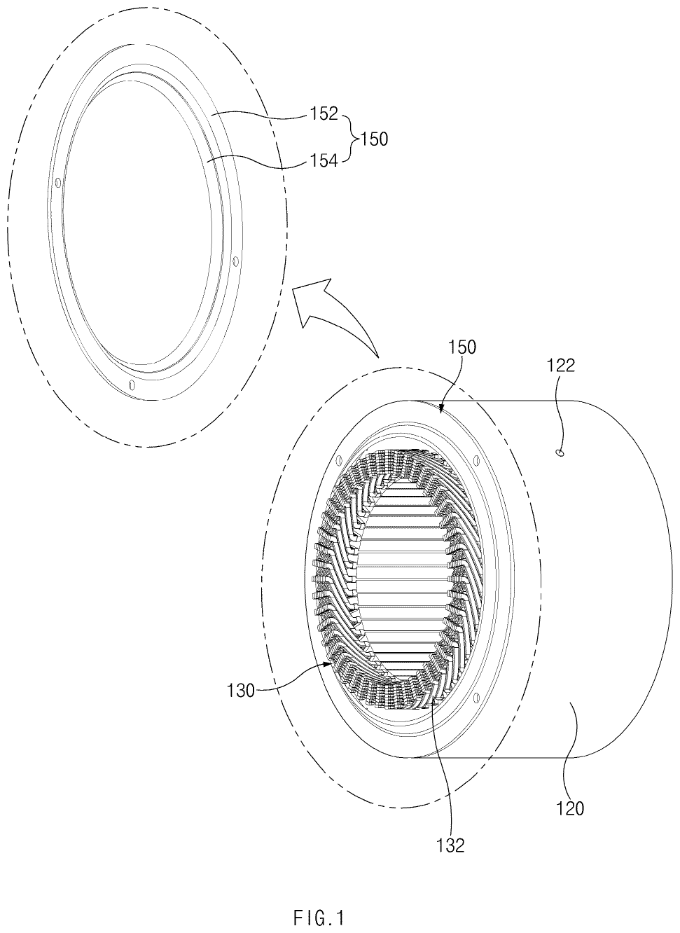

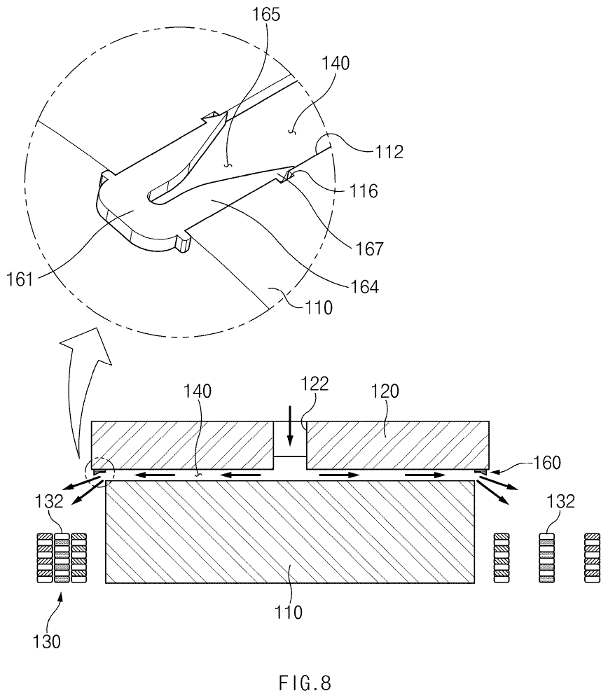

With reference to FIGS. 1 to 8, a motor 10 according to an embodiment of the present disclosure includes a stator 110, a coil 130 wound around the stator 110, a housing member 120 configured to surround a circumference of the stator 110 and having a cooling medium injection portion 122 through which a cooling medium is injected, guide flow paths 140 defined between the housing member 120 and the stator 110 configured to communicate with the cooling medium injection portion 122 and guide the cooling medium, and a guide member 150 provided at an end of the housing member 120 and configured to guide the cooling medium, which is discharged from the guide flow path 140, toward end-turn portions 132 of the coil 130 exposed to an end of the stator 110.

For reference, the motor 10 according to the embodiment of the present disclosure may be applied to various objects in accordance with required conditions and design specifications. The present disclosure is not restricted or limited by the type and properties of the object to which the motor 10 is applied.

For example, the motor 10 according to the embodiment of the present disclosure may be used as a drive motor for a hybrid vehicle or an electric vehicle.

With reference to FIGS. 1 to 3, the stator 110 is configured to induce an electrical interaction collectively with a rotor (not illustrated).

More specifically, the stator 110 may be accommodated in the housing member 120, and the coil 130 may be wound around the stator 110 and configured to induce an electrical interaction between the stator and the rotor.

More specifically, the stator 110 may include a stator core (not illustrated) provided to have a hollow cylindrical shape.

The stator core may have various structures in which a plurality of teeth (not illustrated) is provided along an inner circumferential surface thereof and spaced apart from one another, and slots (not illustrated) are defined between the teeth. The present disclosure is not restricted or limited by the structure and size (standard) of the stator core.

For example, the stator core may be made by stacking a plurality of electric steel sheets in an axial direction of the stator 110. According to another embodiment of the present disclosure, the stator core may be made by using a plurality of split cores that collectively defines a ring shape.

The coil 130 may be made of a typical metallic material (e.g., copper) capable of defining a magnetic path. The present disclosure is not restricted or limited by the material and shape of the coil 130.

For example, an annular coil 130 having a circular cross-section may be used as the coil 130. According to another embodiment of the present disclosure, a flat coil (also referred to as an angular copper wire or a hairpin) having an angular cross-section (e.g., a quadrangular cross-section) may be used as the coil.

In the state in which the coil 130 is disposed (wound) in the stator 110, the end-turn portions 132 of the coil 130, which are exposed to the outside of the stator 110 (left and right ends of the stator based on an axial direction based on FIG. 1), may be twisted in a predetermined posture and then welded. For example, end turn portions 132 of the coil 130, which are exposed to the outside of the stator 110, may be disposed to define an approximately ring shape.

The rotor is rotated by an electrical interaction between the rotor and the stator 110 and configured to provide driving power to the object.

The rotor may have various structures capable of being rotated by the electrical interaction between the rotor and the stator 110. The present disclosure is not restricted or limited by the type and structure of the rotor.

For example, the rotor may include a rotor core (not illustrated) and magnets (not illustrated). The rotor core may have a structure made by stacking a plurality of circular plates each provided in the form of a thin steel sheet or be provided in the form of a bin.

A shaft hole (not illustrated) may be provided at a center of the rotor, and a shaft may be coupled to the shaft hole.

Protrusions (not illustrated) may protrude from an outer circumferential surface of the rotor core and guide the magnets. The magnets may be attached to the outer circumferential surface of the rotor core and spaced apart from one another at predetermined intervals in a circumferential direction of the rotor core.

In addition, the rotor may include a can member (not illustrated) configured to surround the magnets and inhibit the separation of the magnets.

The housing member 120 is provided to surround the circumference of the stator 110. The cooling medium injection portion 122, through which the cooling medium is injected, is provided in the housing member 120.

The housing member 120 may have various structures capable of surrounding the circumference of the stator 110. The present disclosure is not restricted or limited by the structure and shape of the housing member 120.

In particular, the housing member 120 may be provided in an approximately circular cylindrical shape that continuously surrounds a circumference of the coil 130.

For reference, in the embodiment of the present disclosure illustrated and described above, the example has been described in which the housing member 120 is provided in a cylindrical shape that continuously surrounds the circumference of the stator 110. However, according to another embodiment of the present disclosure, the housing member may be configured to partially surround a part of the circumference of the stator (e.g., have a circular arc shape).

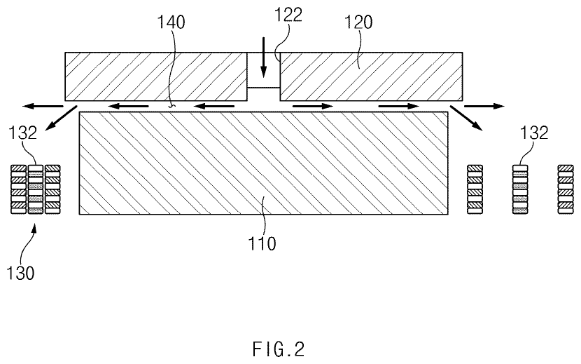

With reference to FIGS. 1 and 2, the cooling medium injection portion 122 is formed through a wall surface of the housing member 120 so that the cooling medium is injected into the housing member 120.

For reference, in the embodiment of the present disclosure, the cooling medium may be defined as a refrigerant (cooling medium) for cooling the coil 130 (or the stator). The present disclosure is not restricted or limited by the type and properties of the cooling medium. Hereinafter, an example will be described in which oil having a lower temperature than the coil 130 is used as the cooling medium.

The cooling medium injection portion 122 may have various structures capable of injecting the cooling medium. The present disclosure is not restricted or limited by the structure and shape of the cooling medium injection portion 122.

For example, the cooling medium injection portion 122 may have an approximately circular hole shape and be formed through the wall surface of the housing member 120.

In particular, the cooling medium injection portion 122 may be provided in an approximately central portion of the housing member 120 based on a longitudinal direction of the housing member 120 (the axial direction of the stator).

As described above, because the cooling medium injection portion 122 is provided in an approximately central portion of the housing member 120 based on the axial direction of the stator 110, it is possible to obtain an advantageous effect of supplying the cooling medium, which is injected through the cooling medium injection portion 122, to the end-turn portions 132 at two opposite sides of the coil 130 under a uniform condition (e.g., at a uniform temperature and a uniform flow rate).

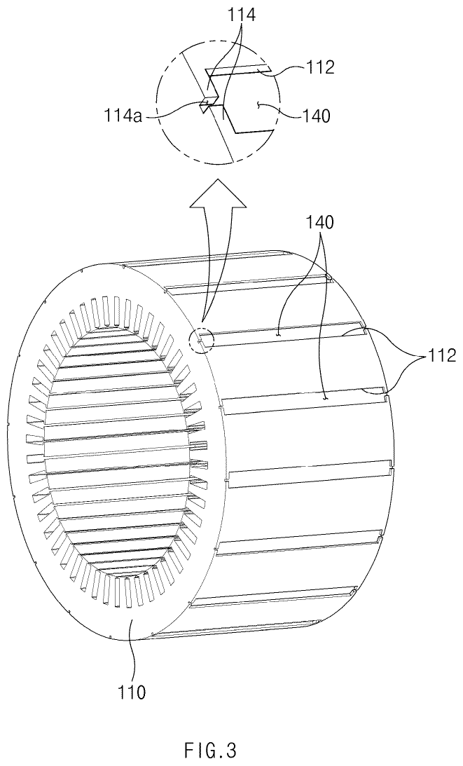

With reference to FIGS. 2 to 3, the guide flow paths 140 are defined between the housing member 120 and the stator 110 and configured to communicate with the cooling medium injection portion 122 and guide the cooling medium, which is injected through the cooling medium injection portion 122, to the end of the stator 110 (the end-turn portions of the coil).

In the embodiment of the present disclosure, the configuration in which the guide flow paths 140 are defined between the housing member 120 and the stator 110 is defined as including both a configuration in which the guide flow paths 140 are formed in an inner surface of the housing member 120 or an outer surface of the stator 110 and a configuration in which the guide flow paths 140 are respectively formed in the inner surface of the housing member 120 and the outer surface of the stator 110.

For example, the motor 10 may include guide grooves 112 provided in the outer surface of the stator 110 in a longitudinal direction of the stator 110, and the guide flow paths 140 may be defined along the guide grooves 112.

In particular, the guide flow path 140 may have a shape straight in the longitudinal direction of the stator 110. According to another embodiment of the present disclosure, the guide flow path may be formed to be inclined with respect to the longitudinal direction of the stator, or the guide flow path may be formed in a curved shape.

With the above-mentioned structure, the cooling medium injected through the cooling medium injection portion 122 may move along the guide flow paths 140 to the end-turn portions 132 of the coil 130 exposed to the end of the stator 110. As the cooling medium moves along the guide flow paths 140, all a core portion of the coil 130 (or the stator) and the end-turn portions 132 of the coil 130 may be cooled.

With reference to FIG. 3, according to the exemplary embodiment of the present disclosure, the motor 10 may include guide protrusions 114 provided at ends of the guide grooves 112 and configured to define outlet flow paths 114a each having a smaller cross-sectional area than the guide flow path 140.

For example, the guide protrusions 114 may be respectively provided on two opposite inner wall surfaces (a first inner wall surface and a second inner wall surface) of the end of the guide groove 112. The outlet flow path 114a, which has a smaller cross-sectional area than the guide flow path 140, may be defined between the guide protrusions 114 that face each other. According to another embodiment of the present disclosure, the guide protrusion may be provided only on any one of the two opposite inner wall surfaces of the end of the guide groove.

As described above, in the embodiment of the present disclosure, the outlet flow path 114a, through which the cooling medium supplied along the guide flow path 140 is finally discharged, has a smaller cross-sectional area than the guide flow path 140, such that a discharge speed of the cooling medium to be discharged along the outlet flow path 114a may be increased on the basis of the Bernoulli's principle, and the cooling medium may be sprayed to the end-turn portions 132 of the coil 130. Therefore, it is possible to obtain an advantageous effect of further improving the efficiency and performance in cooling the end-turn portions 132 of the coil 130.

With reference to FIGS. 1 and 2, the guide member 150 is provided to allow the cooling medium discharged from the guide flow path 140 to have directionality so that the cooling medium is directed toward the end-turn portion 132 of the coil 130. In other words, the guide member 150 is provided to allow the cooling medium discharged from the guide flow path 140 to be concentratedly supplied to the end-turn portion 132 of the coil 130.

The guide member 150 may have various structures capable of guiding the cooling medium, which is discharged from the guide flow path 140, to the end-turn portion 132 of the coil 130. The present disclosure is not restricted or limited by the structure of the guide member 150.

According to the exemplary embodiment of the present disclosure, the guide member 150 may include a connection portion 152 connected to the end of the housing member 120, and a guide portion 154 provided at an end of the connection portion 152 and configured to guide the cooling medium, which is discharged from the guide flow path 140, toward the end-turn portion 132.

For example, the connection portion 152 may have an approximately hollow ring shape and be connected to the end of the housing member 120 (e.g., fastened by a fastening bolt). The guide portion 154 may be bent and integrated with the end of the connection portion 152 while facing the outlet of the guide flow path 140.

As described above, in the embodiment of the present disclosure, the cooling medium discharged from the guide flow path 140 comes into contact with the guide portion 154 and then is guided to the end-turn portions 132 of the coil 130, such that the cooling medium may be concentratedly supplied to the end-turn portions 132 of the coil 130. Therefore, it is possible to obtain an advantageous effect of further improving the efficiency in cooling the end-turn portions 132 of the coil 130.

According to the exemplary embodiment of the present disclosure, the guide portion 154 may be provided to be inclined with respect to the connection portion 152 so that the guide portion 154 is directed toward the end-turn portion 132.

In this case, the configuration in which the guide portion 154 is provided to be inclined with respect to the connection portion 152 may be understood as a configuration in which the guide portion 154 is disposed to be inclined at a predetermined angle with respect to a radial direction of the stator 110.

An angle of the guide portion 154 with respect to the connection portion 152 may be variously changed in accordance with the structure and specifications of the end-turn portion 132 of the coil 130. The present disclosure is not restricted or limited by the angle of the guide portion 154 with respect to the connection portion 152.

As described above, in the embodiment of the present disclosure, the guide portion 154 is provided to be inclined with respect to the connection portion 152. Therefore, it is possible to obtain an advantageous effect of minimizing a situation in which the cooling medium discharged from the guide flow path 140 scatters backward in random directions when the cooling medium comes into contact with the guide portion 154. Further, it is possible to obtain an advantageous effect of more accurately controlling a spray direction of the cooling medium to the direction toward the end-turn portion 132 of the coil 130.

In addition, with reference to FIG. 2, according to the exemplary embodiment of the present disclosure, the motor 10 may include an inclined guiding portion 124 provided integrally with the end of the housing member 120 and configured to guide the cooling medium, which is discharged from the guide flow path 140, toward the end-turn portions 132.

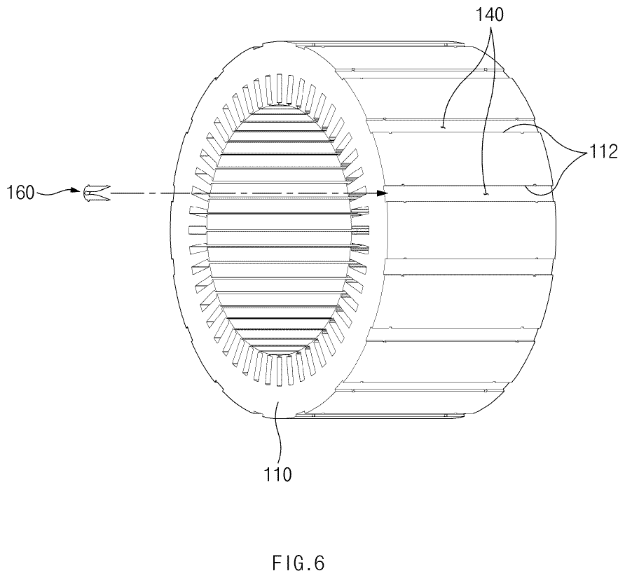

For example, the above-mentioned guide member 150 may be provided at one end (the left end based on FIG. 6) of the housing member 120, and the inclined guiding portion 124 may be integrated with the other end (the right end based on FIG. 6) of the housing member 120.

For example, the inclined guiding portion 124 and the housing member 120 may be formed as a unitary one-piece structure by partially processing the end of the housing member 120.

An angle of the inclined guiding portion 124 may be variously changed in accordance with the structure and specifications of the end-turn portion 132 of the coil 130. The present disclosure is not restricted or limited by the angle of the inclined guiding portion 124.

As described above, in the embodiment of the present disclosure, the inclined guiding portion 124 is provided at the end of the housing member 120. Therefore, it is possible to obtain an advantageous effect of more accurately controlling the spray direction of the cooling medium, which is discharged from the guide flow path 140, to the direction toward the end-turn portion 132 of the coil 130.

In the embodiment of the present disclosure illustrated and described above, the example has been described in which the guide portion 154 is provided to be inclined with respect to the connection portion 152. However, according to another embodiment of the present disclosure, the guide portion may extend in a radial direction of the connection portion.

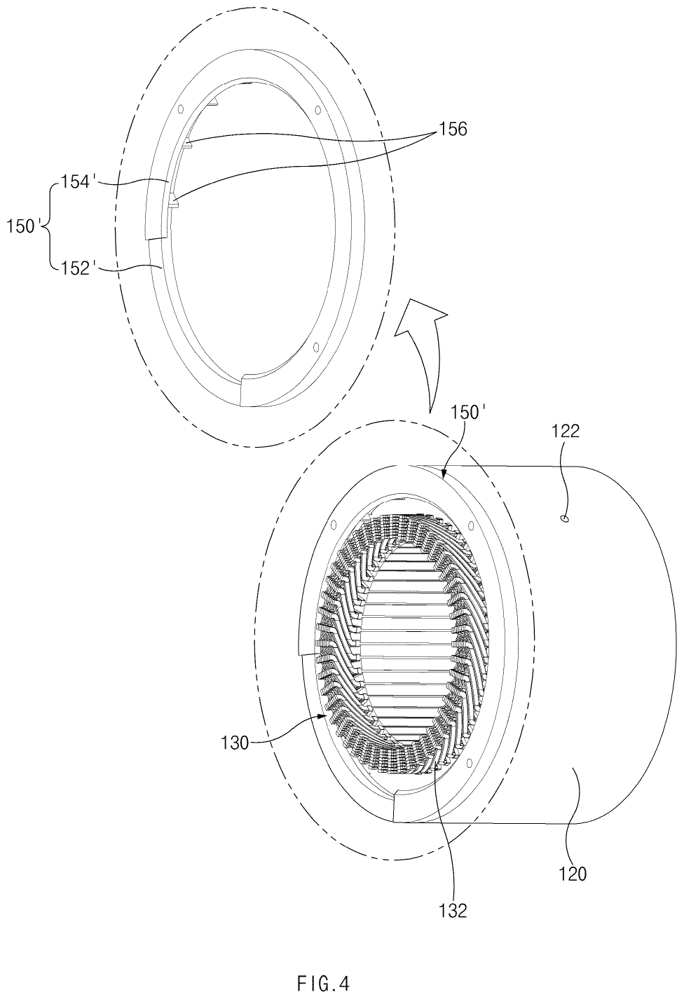

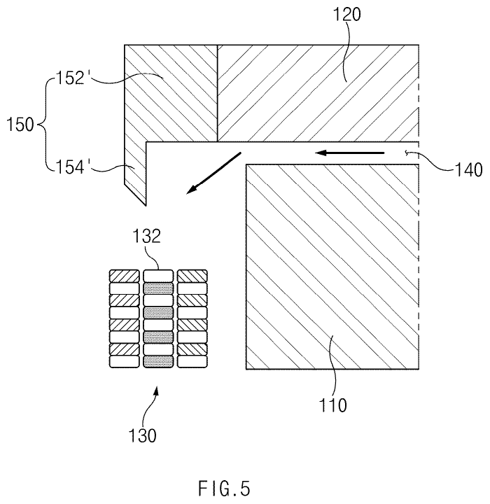

That is, with reference to FIGS. 4 and 5, the guide member 150 may include a connection portion 152′ connected to the end of the stator 110, and a guide portion 154′ provided at an end of the connection portion 152′ and configured to guide the cooling medium, which is discharged from the guide flow path 140, toward the end-turn portion 132. The guide portion 154′ may extend in a radial direction of the connection portion 152′ (the radial direction of the stator) and be disposed to cover the outlet of the guide flow path 140.

In addition, with reference to FIG. 4, according to the exemplary embodiment of the present disclosure, the motor 10 may include guide baffles 156 provided on an inner circumferential surface of the guide portion 154′ and protruding in the longitudinal direction of the housing member 120.

The guide baffle 156 may be provided to be inclined at a predetermined angle with respect to a radial direction of the guide member 150. The present disclosure is not restricted or limited by the arrangement angle of the guide baffle 156.

In particular, the guide baffles 156 may be provided as a plurality of guide baffles 156 provided to be spaced apart from one another in a circumferential direction of the guide member 150.

As described above, in the embodiment of the present disclosure, the guide baffles 156 are provided on the inner circumferential surface of the guide portion 154′, such that the cooling medium discharged from the guide flow path 140 may be guided to the end-turn portion 132 of the coil 130 without stagnating on the inner circumferential surface of the guide portion 154′ or flowing downward to a lower end (a lower end based on a gravitational direction) of the guide portion 154′ in a circumferential direction of the guide portion 154′. Therefore, it is possible to obtain an advantageous effect of more accurately controlling the supply direction of the cooling medium to the direction toward the end-turn portion 132 of the coil 130.

With reference to FIGS. 6 to 8, according to the exemplary embodiment of the present disclosure, the motor 10 may include guide clips 160 provided at the ends of the guide grooves 112 and configured to guide the cooling medium toward the end-turn portions 132.

The guide clip 160 is provided to allow the cooling medium discharged from the guide flow path 140 to have directionality so that the cooling medium is directed toward the end-turn portions 132 of the coil 130. In other words, the guide member 150 is provided to allow the cooling medium discharged from the guide flow path 140 to be concentratedly supplied to the end-turn portions 132 of the coil 130.

Hereinafter, an example will be described in which the guide clips 160 are respectively provided at two opposite ends of the guide flow path 140.

The guide clip 160 may have various structures capable of guiding the cooling medium, which is discharged from the guide flow path 140, to the end-turn portion 132 of the coil 130. The present disclosure is not restricted or limited by the structure of the guide clip 160.

According to the exemplary embodiment of the present disclosure, the guide clip 160 may include a head portion 161 provided at an end of the guide groove 112, a first leg portion 163 connected to one end of the head portion 161 and supported on the first inner wall surface of the guide groove 112, a second leg portion 164 connected to the other end of the head portion 161 and supported on the second inner wall surface of the guide groove 112 that faces the first inner wall surface, a discharge flow path 165 defined between the first leg portion 163 and the second leg portion 164 and configured to guide the cooling medium, which moves along the guide flow path 140, to an inner surface of the head portion 161, and an inclined portion 162 provided on the inner surface of the head portion 161 and configured to guide the cooling medium toward the end-turn portion 132.

For example, the head portion 161, the first leg portion 163, and the second leg portion 164 may be connected to collectively define an approximately “U” shape.

For example, the head portion 161, the first leg portion 163, and the second leg portion 164 may each be made of a typical plastic material. The first leg portion 163 and the second leg portion 164 may be supported by the head portion 161 and configured to be elastically movable in directions in which the first leg portion 163 and the second leg portion 164 move toward and away from each other relative to the head portion 161.

The discharge flow path 165 may have various structures capable of guiding the cooling medium, which moves along the guide flow path 140, to the inner surface of the head portion 161. The present disclosure is not restricted or limited by the structure and shape of the discharge flow path 165.

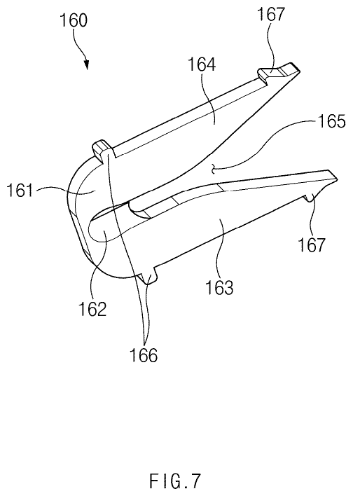

In particular, the discharge flow path 165 may be defined to have a cross-sectional area that gradually decreases in a direction from an inlet (a right side based on FIG. 7), which is adjacent to a central portion of the stator 110, toward an outlet (a left side based on FIG. 7).

As described above, in the embodiment of the present disclosure, the discharge flow path 165 has a cross-sectional area that gradually decreases from the inlet toward the outlet, such that a discharge speed of the cooling medium to be discharged through the outlet of the outlet flow path 114a may be increased on the basis of the Bernoulli's principle, and the cooling medium may be sprayed to the inner surface (inclined portion) of the head portion 161. Therefore, it is possible to obtain an advantageous effect of further improving the efficiency and performance in cooling the end-turn portion 132 of the coil 130.

The inclined portion 162 is provided to guide the cooling medium, which has passed through the discharge flow path 165, toward the end-turn portion 132 of the coil 130 (e.g., the inclined portion 162 is provided to guide the cooling medium in a direction inclined downward with respect to the outlet of the discharge flow path 165.

An angle of the inclined portion 162 may be variously changed in accordance with the structure and specifications of the end-turn portion 132 of the coil 130. The present disclosure is not restricted or limited by the angle of the inclined portion 162.

For example, the inclined portion 162 may have a curved shape. Alternatively, the inclined portion may have a planar shape or other shapes.

As described above, in the embodiment of the present disclosure, the inclined portion 162 is provided on the inner surface of the head portion 161. Therefore, it is possible to obtain an advantageous effect of more accurately controlling the spray direction of the cooling medium, which is discharged from the discharge flow path 165, to the direction toward the end-turn portion 132 of the coil 130.

According to the exemplary embodiment of the present disclosure, the motor 10 may include stopper protrusions 166 protruding from lateral surfaces of the head portion 161.

The stopper protrusions 166 are provided to prevent the guide clip 160 from excessively entering the guide groove 112 when the guide clip 160 enters the guide groove 112.

The stopper protrusion 166 may have various structures capable of being restrained by the end of the stator 110 in the longitudinal direction of the stator 110. The present disclosure is not restricted or limited by the structure and shape of the stopper protrusion 166.

For example, the stopper protrusions 166 may be symmetrically provided on two opposite surfaces of the head portion 161 and each have an approximately quadrangular protrusion shape.

In addition, according to the exemplary embodiment of the present disclosure, the motor 10 may include restraining grooves 116a provided in at least any one of the first inner wall surface and the second inner wall surface, and restraining protrusions 167 provided on at least any one of the first leg portion 163 and the second leg portion 164 and configured to be restrained by the restraining grooves 116a.

Hereinafter, an example will be described in which the restraining protrusions 167 are respectively provided on the first leg portion 163 and the second leg portion 164, and the restraining grooves 116a, which accommodate the restraining protrusions 167, are respectively provided in the first inner wall surface and the second inner wall surface.

The restraining grooves 116a and the restraining protrusions 167 are provided to suppress the separation of the guide clip 160 while securing the state in which the guide clip 160 is disposed in the guide groove 112. The present disclosure is not restricted or limited by the structures and shapes of the restraining groove 116a and the restraining protrusion 167.

For example, the restraining groove 116a may have an approximately quadrangular groove shape, and the restraining protrusion 167 may have an approximately triangular shape.

The restraining protrusions 167 may be moved along the first inner wall surface and the second inner wall surface and then restrained by the restraining grooves 116a in a snap-fit fastening manner by the elastic movements of the first and second leg portions 163 and 164 relative to the head portion 161.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A motor comprising:
a stator;
a coil wound around the stator;
a housing member provided to surround a circumference of the stator and including a cooling medium injection portion for injecting a cooling medium;
a guide flow path defined between the housing member and the stator and configured to communicate with the cooling medium injection portion and guide the cooling medium; and
a guide member provided at an end of the housing member and configured to direct the cooling medium, which is discharged from the guide flow path, toward an end-turn portion of the coil exposed to an end of the stator.

2. The motor of claim 1, wherein the guide member comprises:
a connection portion connected to the end of the housing member; and
a guide portion provided at an end of the connection portion and configured to direct the cooling medium, which is discharged from the guide flow path, toward the end-turn portion of the coil.

3. The motor of claim 2, wherein the guide portion is provided to be inclined with respect to the connection portion and directed toward the end-turn portion of the coil.

4. The motor of claim 2, comprising:
a guide baffle provided on an inner circumferential surface of the guide portion and protruding in a longitudinal direction of the housing member.

5. The motor of claim 1, comprising:
an inclined guiding portion provided integrally with the end of the housing member and configured to direct the cooling medium, which is discharged from the guide flow path, toward the end-turn portion of the coil.

6. The motor of claim 1, comprising:
a guide groove provided in an outer surface of the stator in a longitudinal direction of the stator,
wherein the guide flow path is defined along the guide groove.

7. The motor of claim 6, comprising:
a guide protrusion provided at an end of the guide groove and configured to define an outlet flow path having a smaller cross-sectional area than the guide flow path.

8. The motor of claim 6, comprising:
a guide clip provided at an end of the guide groove and configured to direct the cooling medium toward the end-turn portion of the coil.

9. The motor of claim 8, wherein the guide clip comprises:
a head portion provided at the end of the guide groove;
a first leg portion connected to one end of the head portion and supported on a first inner wall surface of the guide groove;
a second leg portion connected to another end of the head portion and supported on a second inner wall surface of the guide groove that faces the first inner wall surface;
a discharge flow path defined between the first leg portion and the second leg portion and configured to direct the cooling medium, which moves along the guide flow path, to an inner surface of the head portion; and
an inclined portion provided on the inner surface of the head portion and configured to direct the cooling medium toward the end-turn portion of the coil.

10. The motor of claim 9, wherein the discharge flow path is defined to have a cross-sectional area that gradually decreases from an inlet toward an outlet.
